(19) United States
(12) Patent Application Publication
(10) Pub. No.: US 2012/0101748 A1
(43) Pub. Date: Apr. 26, 2012

(54) RECORDING MEDIUM FOR ACOUSTIC ANALYSIS PROGRAM, ACOUSTIC ANALYSIS METHOD, AND ACOUSTIC ANALYSIS DEVICE

(75) Inventors: Sachio KOBAYASHI, Kawasaki (JP); Hiroki Kobayashi, Kawasaki (JP)

(73) Assignee: FUJITSU LIMITED, Kawasaki-shi (JP)

(21) Appl. No.: 13/229,978

(22) Filed: Sep. 12, 2011

(30) Foreign Application Priority Data
Oct. 26, 2010 (JP) 2010-239912

(51) Int. Cl. G06F 19/00

(52) U.S. Cl. 702/56

(57) ABSTRACT

According to an embodiment, a computer-readable, non-transitory medium storing an acoustic analysis program causing a computer to execute a process, the process including: analyzing propagation of a sound generated within a device in an internal analysis space of the device as a first analysis; converting a radiated sound that indicates a result of analysis executed and has been radiated from the inside to the outside of the device to sound energy; and setting a plurality of virtual sound sources to be used as input of a second analysis which is different from the first analysis method on the basis of the sound energy which has been converted from the radiated sound by executing the converting process.

### CROSS-REFERENCE TO RELATED APPLICATION

This application is based upon and claims the benefit of priority of the prior Japanese Patent Application No. 2010-239912, filed on Oct. 26, 2010, the entire contents of which are incorporated herein by reference.

### FIELD

The present invention relates to a recording medium for an acoustic analysis program, an acoustic analysis method, and an acoustic analysis device.

### BACKGROUND

Noise generated from within a device is evaluated through observation performed on the outside of the device. Recently, simulation that allows accurate and short-time noise analysis of a state in which a sound generated from a noise generation source within a device is propagated to the outside of the device has been demanded for quiet design of the device.

As existing methods of simulating sound propagation, geometrical acoustic logical methods such as a Statistical Energy Analysis (SEA) method, a fluid noise analysis method using hydrodynamics, a sound ray method and others are proposed. A place where accurate and short-time noise analysis is allowed is limited to one of the inside and the outside of a device in the above mentioned methods. Thus, it may be also conceived to analyze noise on the inside and the outside of a device using different methods for accurate and short-time noise analysis.

However, a method of analyzing propagation of sounds on the inside and outside of a device by different methods and linking results of both analyses executed with each other for accurate and short-time analysis of sounds such as noise is not known.

Japanese Laid-open Patent Publication No. 2006-268805 and Japanese Laid-open Patent Publication No. 11-337402 are examples of related art.

In addition, http://www.jstage.jst.go.jp/article/seisankenkyu/52/1/3/_pdf/-char/ja/ and “SOUND RAY TRACING METHOD EMBEDDED IN AUTOMATIC ROOM SHAPE GENERATOR OF EACH FREQUENCY”, Journal of Environment Engineering of Architectural Institute of Japan, Vol. 73, No. 625, 267-274, 2008 Mar. 30 are also examples of related art.

### SUMMARY

According to an embodiment, a computer-readable, non-transitory medium storing an acoustic analysis program causing a computer to execute a process, the process including: analyzing propagation of a sound generated within a device in an internal analysis space of the device as a first analysis; converting a radiated sound that indicates a result of analysis executed and has been radiated from the inside to the outside of the device to sound energy; and setting a plurality of virtual sound sources to be used as input of a second analysis which is different from the first analysis on the basis of the sound energy which has been converted from the radiated sound by executing the converting process.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating an example of a configuration of a noise analysis device according to an embodiment 1;

FIG. 2 is a diagram illustrating an example of a relation between an analysis object device and an observation point;

FIG. 3A and FIG. 3B are diagrams illustrating specific examples of calculation of sound powers of sounds through a coupling mesh;

FIG. 4A and FIG. 4B are diagrams illustrating specific examples of point sound source settings;

FIG. 5 is a flowchart illustrating an example of procedures of an acoustic analysis process according to the embodiment 1;

FIG. 6 is a diagram illustrating a specific example of an analysis model (for an SEA method);

FIG. 7 is a diagram illustrating a specific example of an analysis model (for a boundary element method);

FIG. 8 is a diagram illustrating an example of a concept of an analysis condition database (for the SEA method);

FIG. 9 is a diagram illustrating a specific example of acoustic characteristics stored in the form of an array;

FIG. 10 is a diagram illustrating a specific example of an analysis model preparation screen;

FIG. 11 is a diagram illustrating a specific example of an analysis condition setting screen;

FIG. 12 is a diagram illustrating a specific example of an analysis execution screen;

FIG. 13 is a diagram (a numerical value table and a line graph) illustrating a specific example of an analysis result evaluation screen;

FIG. 14 is a diagram illustrating a specific example when a contour map is displayed on an analysis result evaluation screen;

FIG. 15 is a diagram illustrating an specific example when a two-dimensional color map is displayed on an analysis result evaluation screen; and

FIG. 16 is a diagram illustrating an example of a computer that executes an acoustic analysis program.

### DESCRIPTION OF EMBODIMENTS

In the following, an acoustic analysis program, an acoustic analysis method and an acoustic analysis device that the present invention discloses will be described in detail with reference to the accompanying drawings. Incidentally, in the following explanation of embodiments, a case in which the invention is applied to a noise analysis device that analyzes propagation of a sound on the inside and the outside of an analysis object device into which a source that generates noise in sounds is built will be described. However, the present invention is not limited by these embodiments and may be widely applicable to all acoustic analysis devices of the type of analyzing propagation of the sound on the inside and the outside of the analysis object device.

### Embodiments

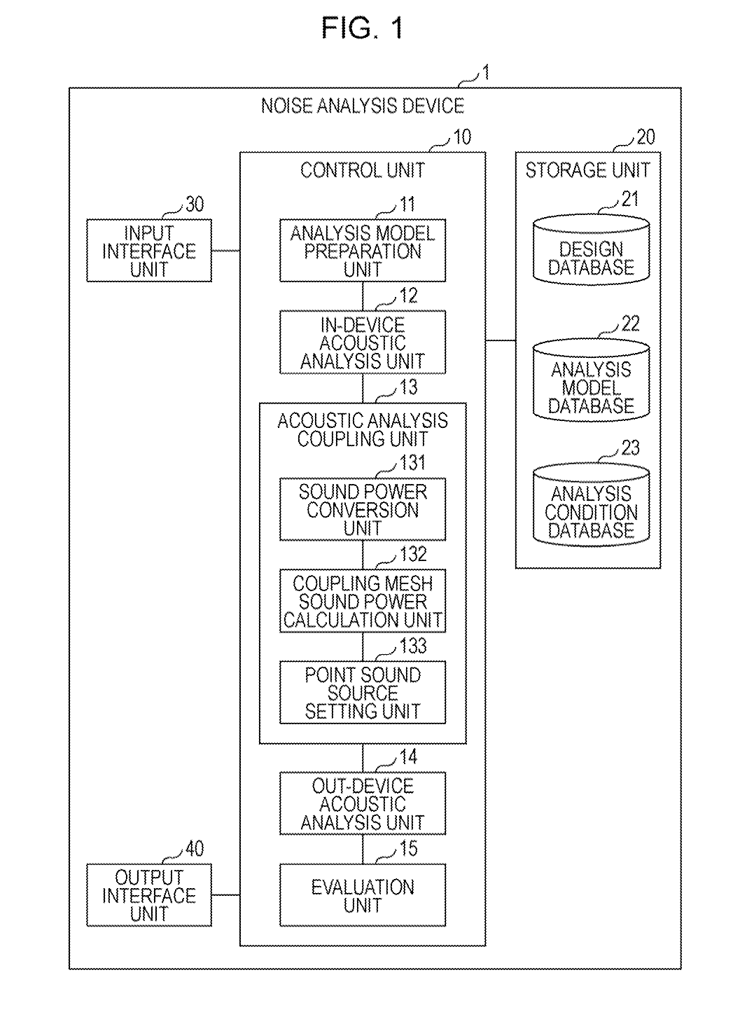

FIG. 1 is a functional block diagram illustrating an example of a configuration of a noise analysis device according to an embodiment 1. As illustrated in the example in FIG. 1, a noise analysis device 1 includes a control unit 10, a storage unit 20, an input interface unit 30 and an output interface unit 40. The control unit 10 includes an analysis model preparation unit 11, an in-device acoustic analysis unit 12, an acoustic analysis coupling unit 13, an out-device acoustic analysis unit 14 and an evaluation unit 15. Incidentally, the control unit 10 is an integrated circuit such as, for example, an ASIC (Application Specific Integrated Circuit), an FPGA (Field Programmable Gate Array) or the like, or an electronic circuit such as, for example, a CPU (Central Processing Unit), an MPU (Micro Processing Unit) or the like.

The storage unit 20 includes a design database 21, an analysis model database 22 and an analysis condition database 23. The design database 21 stores a CAD (Computer Aided Design) model used for preparation of an analysis model. The CAD model includes, for example, three-dimensional model data of an analysis object device that will serve as a design drawing of an analysis model and attributes of materials of components included in the analysis object device.

The analysis model database 22 stores an analysis model. The analysis model includes, for example, information on a mesh that covers a three-dimensional model of the analysis object device. The analysis condition database 23 stores analysis conditions. The analysis conditions include, for example, model attributes, material characteristics, acoustic characteristics, boundary conditions, calculation conditions for frequencies to be analyzed and observation points indicating positions where propagation of a sound is observed of respective elements (rectangular parts or the like) of the analysis model. Incidentally, the storage unit 20 is a storage device such as, for example, a semiconductor memory element such as a RAM (Random Access Memory) or a flash memory, a hard disk, an optical disk or the like.

The input interface unit 30 is a device that a user uses to input operation data and includes, for example, a keyboard, a mouse, a touch-panel type display and/or the like. The output interface unit 40 is a device that outputs a result of evaluation that the evaluation unit 15 has executed and includes, for example, a CRT (Cathode Ray Tube), an LCD (Liquid Crystal Display), a touch-panel type display and/or the like.

The analysis model preparation unit 11 prepares the design database 21, the analysis model database 22 and the analysis condition database 23 in the storage unit 20 in preparation for execution of an acoustic analysis process including noise analysis. Specifically, the analysis model preparation unit 11 stores three-dimensional model data on the analysis object device into the design database 21 on the basis of data that the input interface unit 30 has input.

The analysis model preparation unit 11 also prepares an analysis model corresponding to an analysis method of analyzing propagation of a sound within the analysis object device on the basis of the data that the input interface unit 30 has input and the three-dimensional model data stored in the design database 21. Then, the analysis model preparation unit 11 stores the prepared analysis model into the analysis model database 22.

The analysis model preparation unit 11 further prepares a mesh that covers the analysis object device using the analysis model. Next, the analysis model preparation unit 11 stores information on the prepared mesh into the analysis model database 22. Here, it is supposed that the mesh that covers the analysis object device means a mesh used when linking a result of analysis executed by an analysis method for the inside of the analysis object device to an analysis method for the outside of the analysis object device to couple together the analysis methods both for the inside and the outside of the analysis object device. Hereinafter, it will be referred to as an “analysis coupling mesh”. Incidentally, “couple or coupling” means that results of respective analyses that are executed by different analysis methods in separate analysis spaces relate to each other as a whole. For example, supposing that the analysis method used for analysis of the inside of the analysis object device is an SEA (Statistical Energy Analysis) method and the analysis method used for analysis of the outside of the analysis object device is a geometrical acoustic method, the “analyses coupling mesh” will be used to link a radiated sound which has been analyzed by the SEA method to the geometrical acoustic method to couple together the analysis methods both for the inside and outside of the analysis object device. There exists another mesh that covers the analysis object device and is used when the inside of the analysis object device is analyzed in addition to the “analysis coupling mesh”. The mesh is referred to as an “internal acoustic analysis mesh” and is stored in advance in the analysis model database 22. The “analysis coupling mesh” may be the same as or may be different from the “internal acoustic analysis mesh” as the case may be.

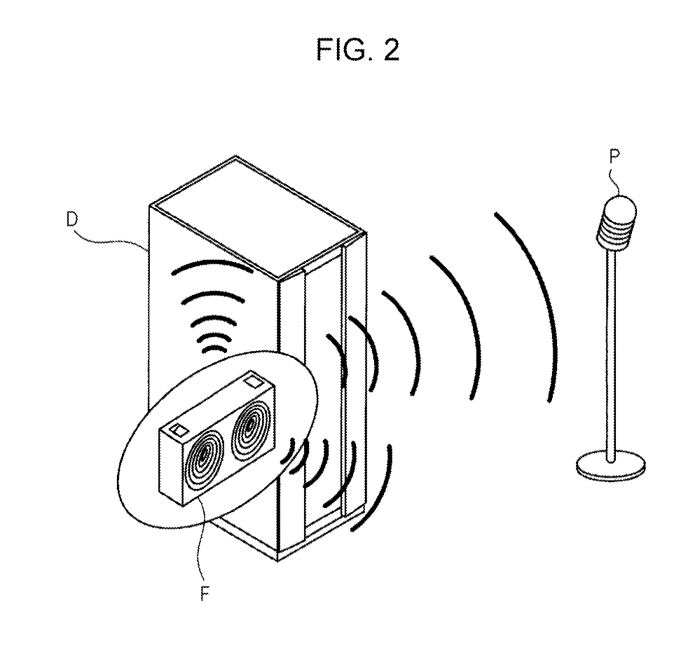

In addition, the analysis model preparation unit 11 stores the analysis conditions including the observation points at which propagation of a sound is observed into the analysis condition database 23 on the basis of the data that the input interface unit 30 has input. In the following, a relation between an analysis object device and an observation point at which propagation of a sound is observed will be described with reference to FIG. 2.

FIG. 2 is a diagram illustrating an example of a relation between an analysis object device and an observation point. As illustrated in the example in FIG. 2, a fan F which is a noise generation source is built in an analysis object device D. The analysis model preparation unit 11 sets a position (an observation point P) at which propagation of noise generated from the fan F is observed is set to the outside of the analysis object device D from its relation with a position where the analysis object device D is arranged in the form of a three-dimensional model and stores the position into the analysis condition database 23. The observation point P is input by a user using the input interface unit 30.

Description will be made returning to FIG. 1, the in-device acoustic analysis unit 12 analyzes propagation of a sound generated within the analysis object device in an internal analysis space of the device using a predetermined analysis method. Specifically, the in-device acoustic analysis unit 12 analyzes propagation of the sound within the analysis object device on the basis of the analysis model stored in the analysis model database 22 by using, for example, the SEA method. Then, the in-device acoustic analysis unit 12 calculates a sound which is radiated to the outside of the analysis object device. In the above mentioned case, the in-device acoustic analysis unit 12 calculates each radiated sound that passes through each element of the internal acoustic analysis mesh.

Incidentally, the unit of the radiated sound which is calculated using the in-device acoustic analysis unit 12 differs for different analysis method adopted. The radiated sound is expressed in various units such as, for example, sound power (watt: W), sound power level (decibel: dB), sound pressure (pascal: Pa), and/or sound pressure level (decibel: dB).

The acoustic analysis coupling unit 13 converts the radiated sound that indicates a result of analysis executed on the analysis object device by an analysis method for the inside of the device to the sound energy and sets a plurality of virtual sound sources used as input of an analysis method for the outside of the analysis object device on the basis of the converted sound energy. That is, the acoustic analysis coupling unit 13 functions to couple together the analysis methods for the inside and the outside of the analysis object device. The analysis method for the external analysis space of the analysis object device is different from the analysis method for the internal analysis space of the analysis object device and is an analysis method which is suited for analysis of the outside of the analysis object device. The acoustic analysis coupling unit 13 includes a sound power conversion unit 131, a coupling mesh sound power calculation unit 132 and a point sound source setting unit 133.

The sound power conversion unit 131 converts the unit of the radiated sound that the in-device acoustic analysis unit 12 has analyzed by a predetermined analysis method, that is, the radiated sound that has been radiated from the inside to the outside of the analysis object device into the sound power (W) on the basis of its sound energy calculated. Here, the sound power is defined as the sound energy of a sound that passes through a designated surface in one second and has an hourly-averaged value of the product of in-phase components of a designated surface, a vertical volume velocity and an instantaneous sound pressure. That is, the sound power conversion unit 131 unifies the units of radiated sounds that have been calculated in units which are different for different analysis methods adopted to the sound power on the basis of the sound energy.

Specifically, the sound power conversion unit 131 converts the unit of the radiated sound that the in-device acoustic analysis unit has calculated by a predetermined analysis method and that passes through the internal acoustic analysis mesh to the sound power. That is, the acoustic power conversion unit 131 converts the units of radiated sounds that have been calculated in units which are different for different analysis methods adopted to the sound power one by one.

For example, when the unit of a radiated sound is the sound power level, the acoustic power conversion unit 131 converts the sound power level to the sound power. In the above mentioned situation, the sound power level Lw (unit: dB) is expressed by the following formula (1) from its relation with the sound power P (unit: W):

Lw=10 log₁₀ P/Pₒ (1)

In the formula, Pₒ denotes a reference sound power (unit: W) and is 10⁻¹² (W).

The sound power P is expressed by the following formula (2) from the formula (1):

$$P = {10}^{\frac{{L}_{W}}{10} - 12} \qquad ( 2 )$$

That is, the sound power conversion unit 131 converts the sound power level Lw to the sound power P by calculating the formula (2).

In addition, when the unit of the radiated sound is the sound pressure level, the sound power conversion unit 131 converts the sound pressure level to the sound power. Here, the sound pressure level Lp (unit: dB) is expressed by the following formula (3) from its relation with the sound power level Lw (unit: dB):

Lw=Lp+10 log₁₀ 4π (3)

Then, the sound power conversion unit 131 is allowed to convert the sound pressure level Lp to the sound power P by substituting the sound power level Lw obtained from the formula (3) for the formula (2).

Further, when the unit of the radiated sound is the sound pressure, the sound power conversion unit 131 converts the sound pressure to the sound power. Here, the sound pressure p (unit: Pa) is expressed by the following formula (4) from its relation with the sound pressure level Lp (unit: dB):

$${L}_{P} = 10 {log}_{10} \frac{{p}^{2}}{{p}_{0}^{2}} \qquad ( 4 )$$

In the formula, pO denotes an effective value (unit: Pa) of a reference sound pressure and 20×10⁻⁶ (unit: Pa)=20 (unit: μPa)

Then, the sound power conversion unit 131 is allowed to convert the sound pressure p to the sound power P by substituting the sound pressure level Lp obtained from the formula (4) for the formula (3) to obtain the sound power level Lw and substituting the obtained sound power level Lw for the formula (2).

Description will be made returning to FIG. 1. The coupling mesh sound power calculation unit 132 calculates a plurality of sound powers used as input of an analysis method for the sound in the external analysis space of the analysis object device on the basis of the sound power (the sound energy) which has been converted by the sound power conversion unit 131. Specifically, the coupling mesh sound power calculation unit 132 calculates the sound power of the sound passing through each element of an analysis coupling mesh by using the sound power so converted per radiated sound that passes through the internal acoustic analysis mesh.

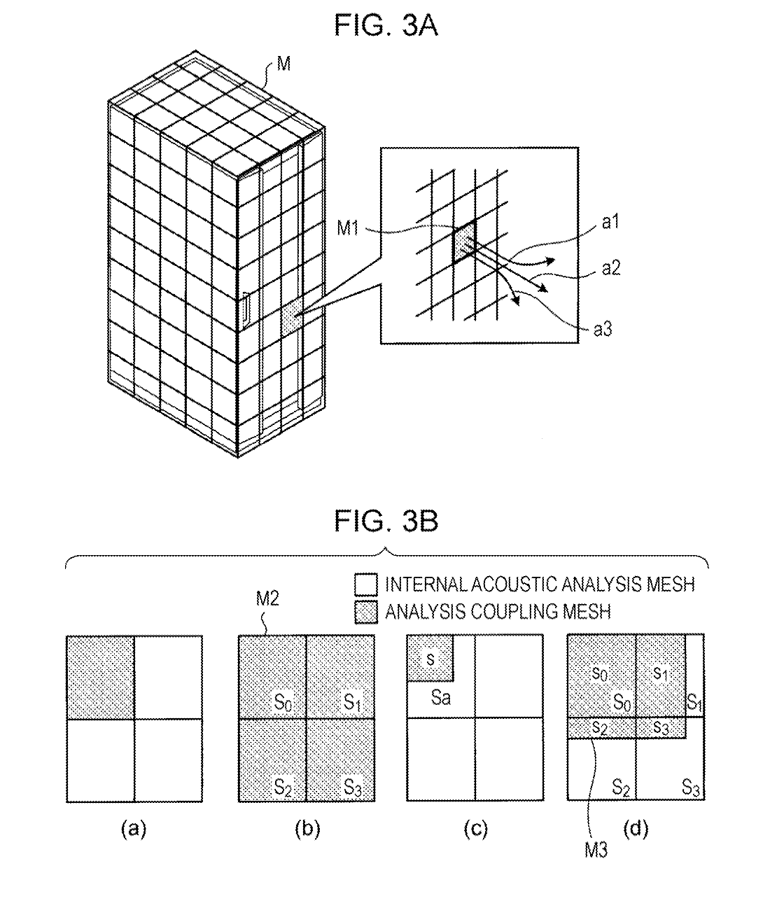

In the following, specific examples of calculation of sound powers of sounds passing through an analysis coupling mesh that the coupling mesh sound power calculation unit 132 executes will be described with reference to FIG. 3A and FIG. 3B.

FIG. 3A and FIG. 3B are diagrams illustrating specific examples of calculation of sound powers of sounds passing through an analysis coupling mesh, in which FIG. 3A is a diagram illustrating an example of a concept of calculation of sound powers of sounds passing through the analysis coupling mesh and FIG. 3B is a diagram illustrating examples of methods of calculating the sound powers of sounds passing through the analysis coupling mesh from a relation between the internal acoustic analysis mesh and the analysis coupling mesh.

As illustrated in the example in FIG. 3A, the coupling mesh sound power calculation unit 132 calculates the sound power (the sound energy) of the sound passing through each element of an analysis coupling mesh M that covers an analysis object device. In the example illustrated in FIG. 3, the coupling mesh sound power calculation unit 132 sums up sound powers a1 to a3 of the sound passing through, for example, an element M1 of the analysis coupling mesh M and sets a value obtained by summing up the sound powers as the sound power of the sound passing through the element M1.

When respective elements of the internal acoustic analysis mesh and the analysis coupling mesh align with each other as illustrated in an example (a) in FIG. 3B, the sound power of the sound passing through each element of the analysis coupling mesh coincides with the sound power of the sound passing through the corresponding element of the internal acoustic analysis mesh. In the above mentioned situation, the coupling mesh sound power calculation unit 132 sets the sound power of the sound passing through one element of the analysis coupling mesh to a value obtained by summing up the sound powers of the sound passing through the element of the inner acoustic analysis mesh which is situated as the same position as the above element of the analysis coupling mesh.

When one element of the analysis coupling mesh includes therein a plurality of elements of the internal acoustic analysis mesh as illustrated in an example (b) in FIG. 3B, the sum of sound powers of the sound passing through the plurality of elements of the inner acoustic analysis mesh indicates the sound power P of the sound passing through one element of the analysis coupling mesh. That is, the sound power P of the sound passing through one element of the analysis coupling mesh is expressed by the following formula (5):

$$P = {\sum }_{i = 0}^{n - 1} {P}_{i} \qquad ( 5 )$$

In the formula, n is the number of a plurality of elements of the inner acoustic analysis mesh which are included in one element of the analysis coupling mesh and Pi is the sound power (unit: W) of the sound passing through an i-th element in the plurality of elements of the internal acoustic analysis mesh. Here, the coupling mesh sound power calculation unit 132 calculates the sound power of the sound passing through an element M2 of the analysis coupling mesh to obtain a value (P_{O}+P₁+P₂+P₃).

When one element of the analysis coupling mesh is included in a part of one element of the internal acoustic analysis mesh as illustrated in an example (c) in FIG. 3B, the sound power P of the sound passing through one element of the analysis coupling mesh is expressed by the following formula (6):

$$P = \frac{s}{{S}_{a}} {P}_{a} \qquad ( 6 )$$

In the formula, Pa is the sound power of the sound passing through one element of the internal acoustic analysis mesh, Sa is the area of that element, and s is the area of the element of the analysis coupling element which is included in a part of that element.

When one element of the analysis coupling mesh includes a part of the internal acoustic analysis mesh striding over a plurality of elements of the internal acoustic mesh as illustrated in an example (d) in FIG. 3B, the sound power P of the sound passing through one element of the analysis coupling mesh is expressed by the following formula (7):

$$P = {\sum }_{i = 0}^{n - 1} \frac{{s}_{i}}{{S}_{i}} {P}_{i} \qquad ( 7 )$$

In the formula, n is the number of a plurality of elements of the internal acoustic analysis mesh relating to one element of the analysis coupling mesh, Pi is the sound power (unit: W) of the sound passing through an i-th element in the plurality of elements of the internal acoustic analysis mesh, and si is the area of one element of the analysis coupling mesh that overlaps the i-th element in the plurality of elements of the internal acoustic analysis mesh. Here, the coupling mesh sound power calculation unit 132 calculates the sound power of the sound passing through an element M3 of the analysis coupling mesh to obtain a value (P_{O}+P₁S₁/S₁+P₂s₂/S₂+P₃S₃/S₃).

Description will be made returning to FIG. 1. The point sound source setting unit 133 sets the sound power of the sound passing through each element of the analysis coupling mesh as each point sound source. That is, the point sound source which is set for each element of the analysis coupling mesh serves as a virtual sound source which is an interface from the internal analysis space to the external analysis space of the analysis object device. Specifically, the point sound source setting unit 133 sets each sound power that the coupling mesh sound power calculation unit 132 has calculated for each element of the analysis coupling mesh as each point sound source at the position of the center of gravity of each element.

When a plurality of point sound sources are to be set on one element of the analysis coupling mesh, the point sound source setting unit 133 divides one element into several elements and sets each of sound powers which have been distributed on the basis of the area ratio of the element obtained before divided to the elements obtained after divided as each point sound source at the position of the center of gravity of each divided element. Incidentally, when a plurality of point sound sources are to be set on one element of the analysis coupling mesh, the point sound sources are set under the instruction from a user, for example, via the input interface unit 30.

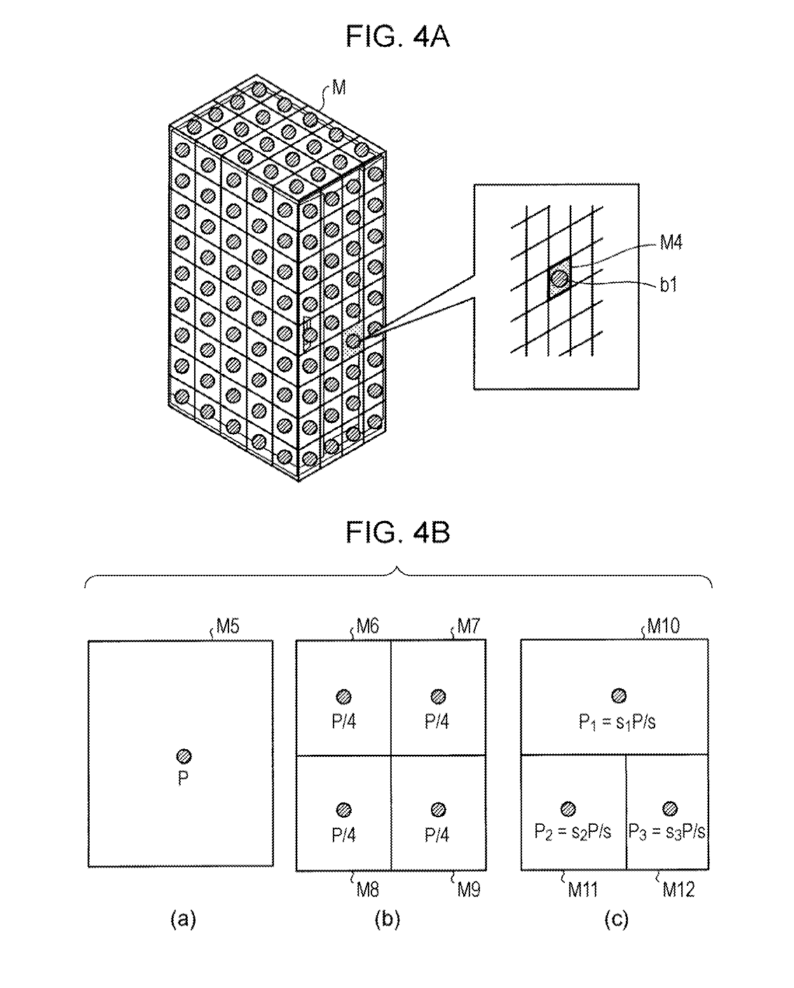

In the following, specific examples of point sound source settings executed using the point sound source setting unit 133 will be described with reference to FIG. 4A and FIG. 4B.

FIG. 4A and FIG. 4B are diagrams illustrating specific examples of point sound source settings, in which FIG. 4A is a diagram illustrating an example of a concept of point sound source setting and FIG. 4B is a diagram illustrating examples of point sound source settings when an element is divided into several elements.

As illustrated in the example in FIG. 4A, the sound power (the sound energy) of a sound passing through each element of the analysis coupling mesh M is set at the position of the center of gravity of each element using the point sound source setting unit 133. For example, as for an element M4 of the analysis coupling mesh M, the point sound source setting unit 133 sets the sound power of the sound passing through the element M4 as a point sound source b1 at the position of the center of gravity of the element M4.

(a) In FIG. 4B is an example in which one element of the analysis coupling mesh is not divided. In the above mentioned case, the point sound source setting unit 133 sets the sound power of the sound passing through the element as a point sound source at the position of the center of gravity of the element. In the example (a), the point sound source setting unit 133 sets the sound power P of the sound passing through an element M5 as the point sound source at the position of the center of gravity of the element M5.

(b) In FIG. 4B is an example in which one element of the analysis coupling mesh is divided into four parts. In the above mentioned case, the point sound source setting unit 133 divides one element of the analysis coupling mesh into four parts and sets each sound power which is one-fourth the sound power of the sound passing through the element before divided as each point sound source at the position of the center of gravity of each divided element. In the example (b), the point sound source setting unit 133 sets each sound power P/4 which is one-fourth the sound power P of the sound passing through the element before divided as each point sound source at the position of the center of gravity of each of divided elements M6 to M9.

(c) In FIG. 4B is an example in which one element of the analysis coupling mesh is divided into some elements so as to respectively have arbitrary areas. In the example (c), the point sound source setting unit 133 divides one element of the analysis coupling mesh into some elements so as to have arbitrary areas under the instruction from the user. Then, the point sound source setting unit 133 distributes the sound power of the sound passing through the element before divided on the basis of the area ratio of the element before divided to the elements obtained after divided and sets each distributed sound power as each point sound source at the position of the center of gravity of each of the divided elements. In the example (c), the point sound source setting unit 133 divides one element having an area s into an element M10 having an area s1, an element M11 having an area s2 and an element M12 having an area s3. In the above mentioned case, the point sound source setting unit 133 sets each sound power Pi (i=1 to 3) expressed by the following formula (8) as each point sound source at the position of the center of gravity of each of the divided elements M10 to M12.

Pi=Psi/s (8)

In the formula, P is the sound power of the sound passing through one element of the analysis coupling mesh obtained before divided, s is the area of the element, and si is the area of an i-th divided element.

Description will be made returning to FIG. 1. The out-device acoustic analysis unit 14 analyzes propagation of the sound in the external analysis space of the analysis object device by inputting a set of point sound sources that the point sound source setting unit 133 has set on the analysis coupling mesh by an analysis method which is different from the analysis method for the inside of the analysis object. Specifically, the out-device acoustic analysis unit 14 analyzes propagation of the sound on the outside of the analysis object device on the basis of the analysis model stored in the analysis model database 22 by using, for example, a geometrical acoustic method. Then, the out-device acoustic analysis unit 14 calculates the sound which is radiated to the observation point disposed on the outside of the analysis object device which is stored in the analysis condition database 23.

The evaluation unit 15 acquires results of acoustic analyses executed on the inside and outside of the analysis object device, edits the acquired results of acoustic analyses and outputs a result of editing to the output interface unit 40. The evaluation unit 15 edits the acquired results of acoustic analyses in the form of, for example, a line graph, a table indicating each numerical value at each observation point, a contour map, and/or a two-dimensional or a three-dimensional color map to be displayed on, for example, a CRT.

[Procedures of Acoustic Analysis Process According to Embodiment]

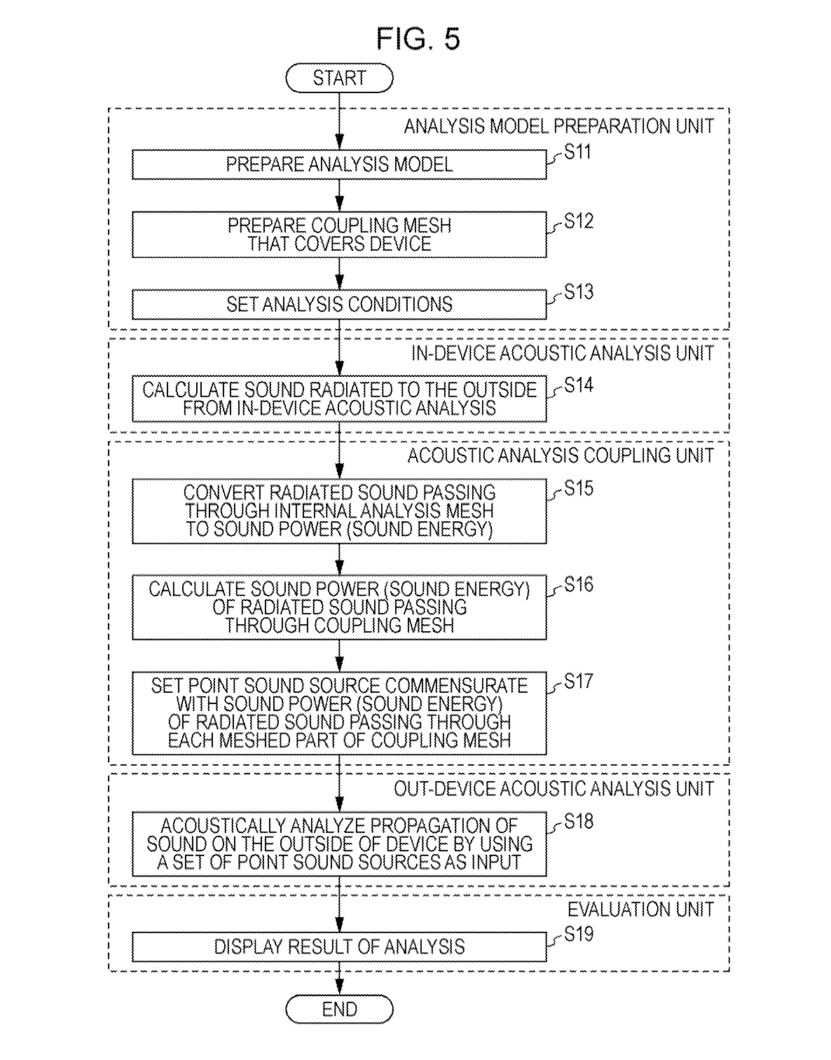

Next, procedures of an acoustic analysis process according to the embodiment will be described with reference to FIG. 5.

FIG. 5 is a flowchart illustrating an example of procedures of an acoustic analysis process according to the embodiment.

First, the analysis model preparation unit 11 prepares three-dimensional model data such as the shape of an analysis model on the basis of data that the input interface unit 30 has input and stores the data into the design database 21. The three-dimensional model data includes, for example, three-dimensional model data of an analysis object device. Then, the analysis model preparation unit 11 prepares an analysis model coping with an analysis method to be adopted on the basis of the data that the input interface unit 30 has input and the three-dimensional model data which is stored in the design database 21 (S11).

Then, the analysis model preparation unit 11 prepares an analysis coupling mesh that covers the analysis object device by using the prepared analysis model (S12). Then, the analysis model preparation unit 11 stores the prepared analysis coupling mesh into the analysis model database 22. Incidentally, an internal acoustic analysis mesh which is used as a result of analysis executed on the inside of the analysis object device is stored in advance in the analysis model database 22 separately from the analysis coupling mesh.

Then, the analysis model preparation unit 11 sets analysis conditions on the basis of the data that the input interface unit 30 has input (S13) and stores the set analysis conditions into the analysis condition database 23. The analysis conditions include, for example, observation points at which propagation of a sound is observed.

Then, the in-device acoustic analysis unit 12 analyzes propagation of the sound generated within the analysis object device on the basis of the analysis model which is stored in the analysis model database by using a predetermined analysis method. Then, the in-device acoustic analysis unit 12 calculates the sound radiated to the outside of the analysis object device (S14). In the above mentioned case, the in-device acoustic analysis unit 12 calculates the radiated sound that passes through each element of the internal acoustic analysis mesh. Incidentally, the SEA method may be given as an example of the predetermined analysis method.

Then, the sound power conversion unit 131 converts the unit of the radiated sound that passes through each element of the internal acoustic analysis mesh that the in-device acoustic analysis unit 12 has calculated to the sound power on the basis of the sound energy (S15). That is, the sound power conversion unit 131 unifies the units of radiated sounds which are calculated in units which are different for different analysis methods to the sound power on the basis of the sound energy.

Then, the coupling mesh sound power calculation unit 132 calculates the sound power of the radiated sound passing through each element of the analysis coupling mesh by using the sound power of the sound passing through each element of the internal acoustic analysis mesh (S16).

Then, the point sound source setting unit 133 sets a point sound source commensurate to the sound power (the sound energy) of the radiated sound passing through each element of the analysis coupling mesh (S17). That is, the point sound source so set serves as a virtual sound source which is an interface from the internal analysis space to the external analysis space of the analysis object device. Specifically, the point sound source setting unit 133 sets the sound power of the sound passing through each element of the analysis coupling mesh that the coupling mesh acoustic power calculation unit 132 has calculated as the point sound source at the position of the center of gravity of each element. Then, when a plurality of point sound sources are to be set on one element of the analysis coupling mesh, the point sound source setting unit 133 divides the element into several elements and sets each sound power which has been distributed to each divided element on the basis of the area ratio of the element obtained before divided to the elements obtained after divided as each point sound source at the position of the center of gravity of each divided element.

Then, the out-device acoustic analysis unit 14 uses a set of point sound sources which have been set on the analysis coupling mesh as input, thereby to acoustically analyze propagation of the sound on the outside of the analysis object device by using an analysis method which is different from the analysis method for the inside of the analysis object device (S18). Incidentally, a geometrical acoustic method may be given as an example of the analysis method for the outside of the analysis object device.

Then, the evaluation unit 15 displays results of acoustic analyses executed on the inside and the outside of the analysis object device on, for example, a CRT (S19).

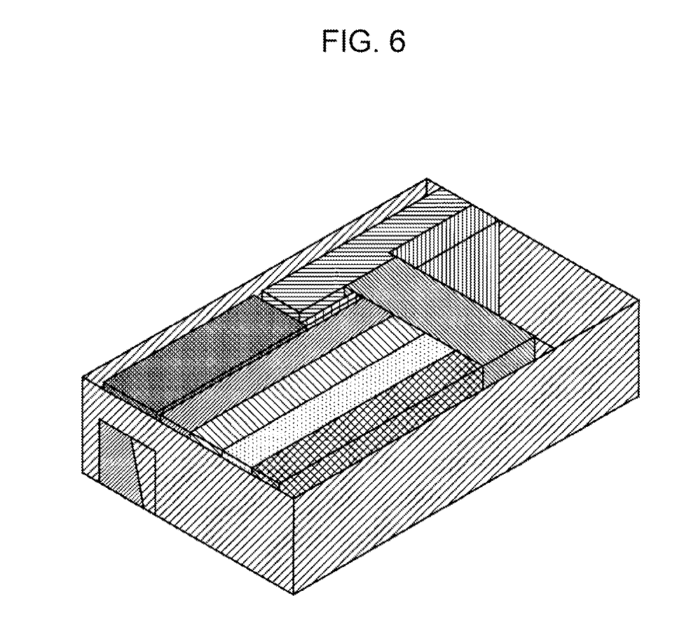

Next, a specific example of an analysis model used when the SEA method is used as the analysis method for the inside of the analysis object device will be described with reference to FIG. 6.

FIG. 6 is a diagram illustrating a specific example of an analysis model (for the SEA method). As illustrated in FIG. 6, the analysis object device is displayed in the form of the analysis model used in the SEA method. Data on the analysis model is stored in the analysis model database 22.

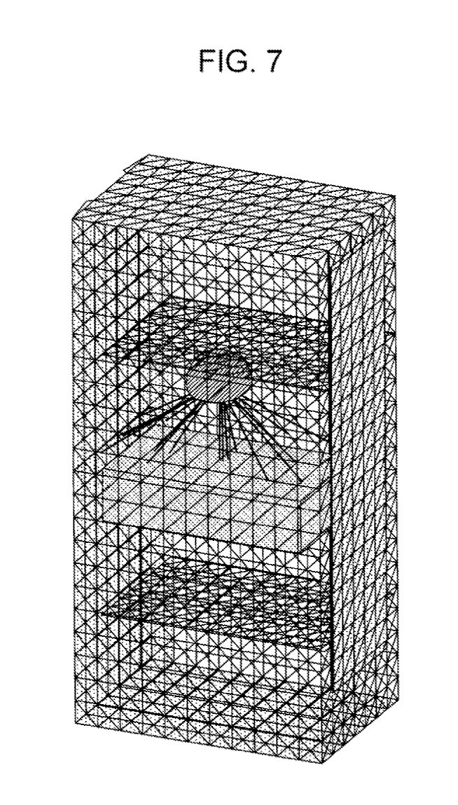

Next, a specific example of an analysis model used when a boundary element method (BEM method) is adopted as the analysis method for the inside of the analysis object device will be described with reference to FIG. 7.

FIG. 7 is a diagram illustrating a specific example of an analysis model (for the boundary element method). As illustrated in FIG. 7, the analysis object device is displayed in the form of the analysis model which is used in the boundary element method. Data on the analysis model is stored in the analysis model database 22.

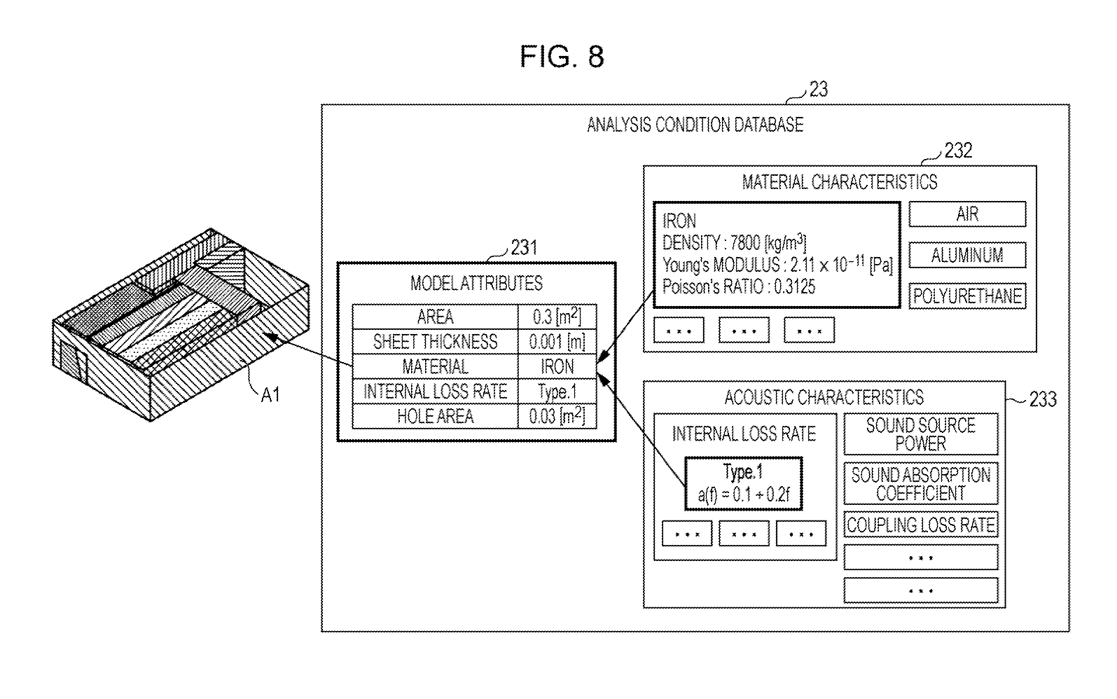

Next, an example of a concept of the analysis condition database 23 used when the SEA method is adopted as the analysis method for the inside of the analysis object device will be described with reference to FIG. 8.

FIG. 8 is a diagram illustrating an example of a concept of the analysis condition database (for the SEA method). As illustrated in FIG. 8, the analysis condition database 23 stores model attributes 231, material characteristics 232 and acoustic characteristics 233 in correspondence with each element (each shaded part or the like) of an analysis model A. Here, description will be made supposing that respective pieces of data are stored in correspondence with an element A1 of the analysis model A.

The area of the surface, the sheet thickness indicating the thickness of the sheet, the material, the internal loss rate and the hole area of the element A1 are stored in the area of the model attributes 231 in correspondence with one another. The material characteristics 232 indicate physical characteristics of the material such as air, ion or the like and the characteristics of the material are stored in the area of the material characteristics 232 in correspondence with the material stored in the area of the model attributes 231. In the example illustrated in FIG. 8, since the material stored in the area of the model attributes 231 is ion, the density, the Young's modulus and the Poisson's ratio that correspond to the physical characteristics of ion are stored in the area of the material characteristics 232. Incidentally, the physical characteristics to be stored are not limited to the density, the Young's modulus and the Poisson's ratio and, for example, the coefficient of viscosity, the Prandtl number, the ratio of specific heat, the loss factor, the modulus of rigidity, the viscous characteristic length, the thermal characteristic length, the flow resistance, the porosity and/or the tortuosity of the material may be stored in the area of the material characteristics 232.

In addition, the acoustic characteristics 233 indicate to which extent the sound is generated, is absorbed or is transmitted per element of the analysis model and the acoustic characteristics corresponding to the type of the internal loss rate are stored in the area of the acoustic characteristics 233. In the example illustrated in FIG. 8, since the type of the internal loss rate which is stored in the area of the model attributes 231 is “Type. 1”, a numerical formula “a (f)=0.1+0.2f” that indicates an acoustic characteristic corresponding to the “Type. 1” and has such a frequency characteristic that an acoustic characteristic a is calculated from a frequency f is stored in the area of the acoustic characteristics 233. Data which is stored in the area of the acoustic characteristics 233 is not limited to a numerical formula having a frequency characteristic and one numerical value or an array may be stored.

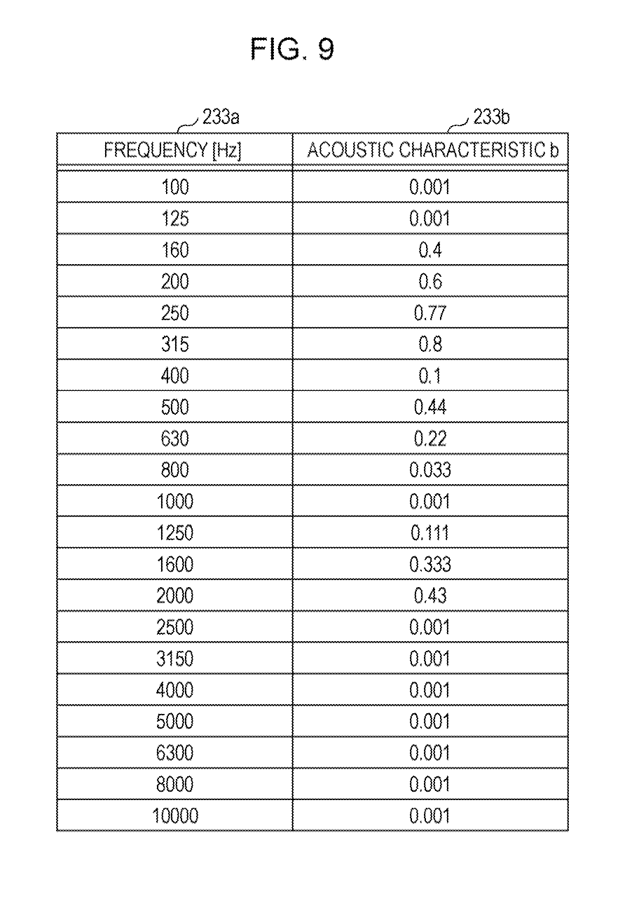

Therefore, a specific example of the acoustic characteristics 233 stored in the form of an array will be described with reference to FIG. 9.

FIG. 9 is a diagram illustrating a specific example of an acoustic characteristic stored in the form of an array. As illustrated in FIG. 9, each frequency 233a and each acoustic characteristic 233b are stored in correspondence with each other in the area of the acoustic characteristics 233. For example, when the value of the frequency 233a is 100 Hz, 0.001 is stored as the value of the acoustic characteristic 233b and when the value of the frequency 233a is 200 Hz, 0.6 is stored as the value of the acoustic characteristic 233b in the area of the acoustic characteristics 233.

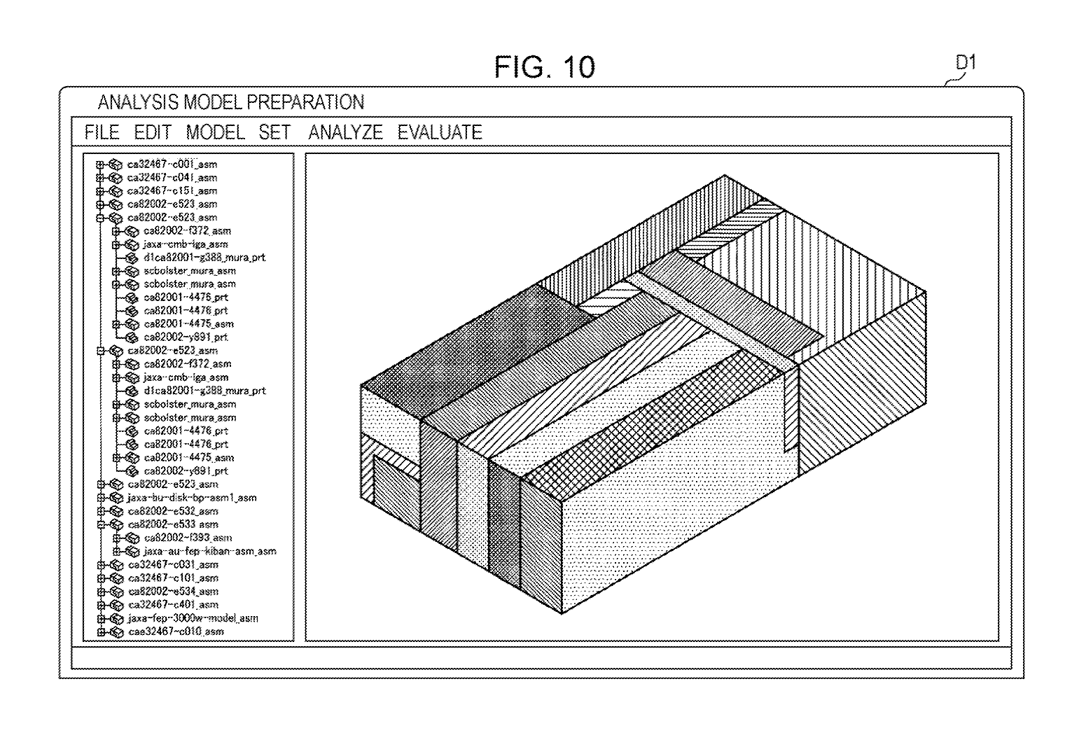

Next, a specific example of an analysis model preparation screen used when an analysis model is prepared using the analysis model preparation unit 11 will be described with reference to FIG. 10. FIG. 10 is a diagram illustrating a specific example of an analysis model preparation screen. As illustrated in FIG. 10, an analysis model which is used in the SEA method is displayed on an analysis model preparation screen D1. The analysis model preparation screen D1 is configured to allow a user to set an analysis model corresponding to an analysis method adopted by using a mouse or the like.

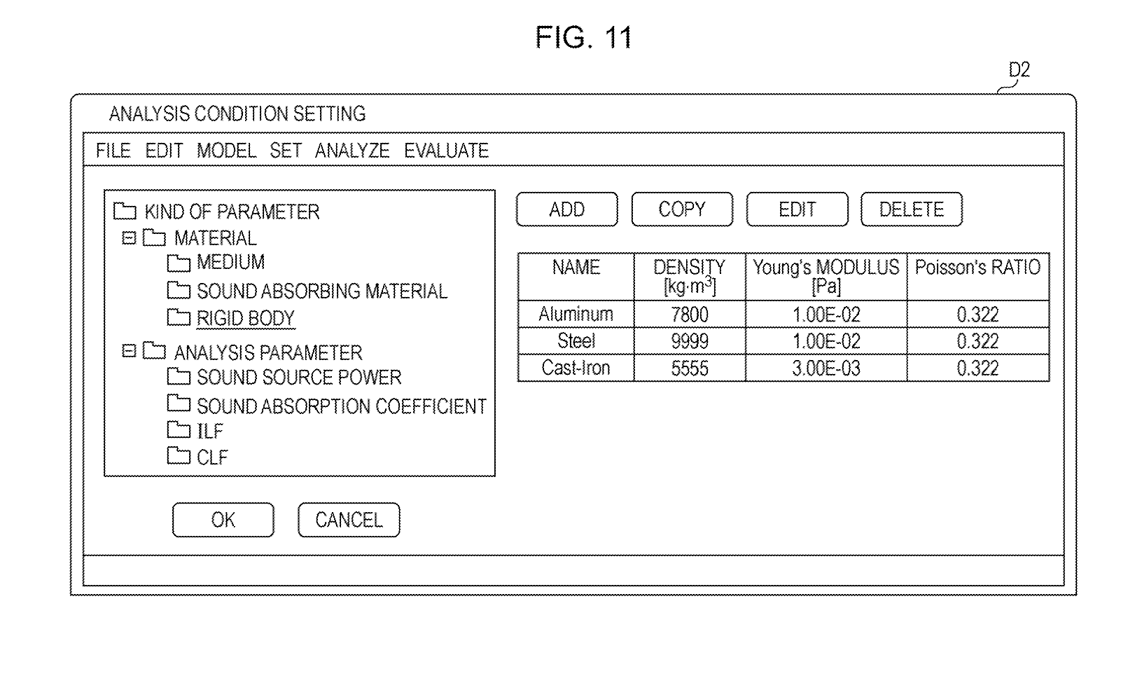

Next, a specific example of an analysis condition setting screen used when the analysis model setting unit 11 sets analysis conditions will be described with reference to FIG. 11.

FIG. 11 is a diagram illustrating a specific example of an analysis condition setting screen. As illustrated in FIG. 11, material characteristics (the density, the Young's modulus and the Poisson's rate) of each material are displayed in correspondence with the name of each material on an analysis condition setting screen D2. The user is allowed to set the material used by using the mouse or the like with reference to the analysis condition setting screen D2. The user is also allowed to set analysis parameters such as the sound power, the absorption coefficient and the like using the mouse or the like with reference to the analysis condition setting screen D2. In addition, although not illustrated in the drawing, the user is allowed to set an observation point at which propagation of the sound is observed with reference to the analysis condition setting screen D2.

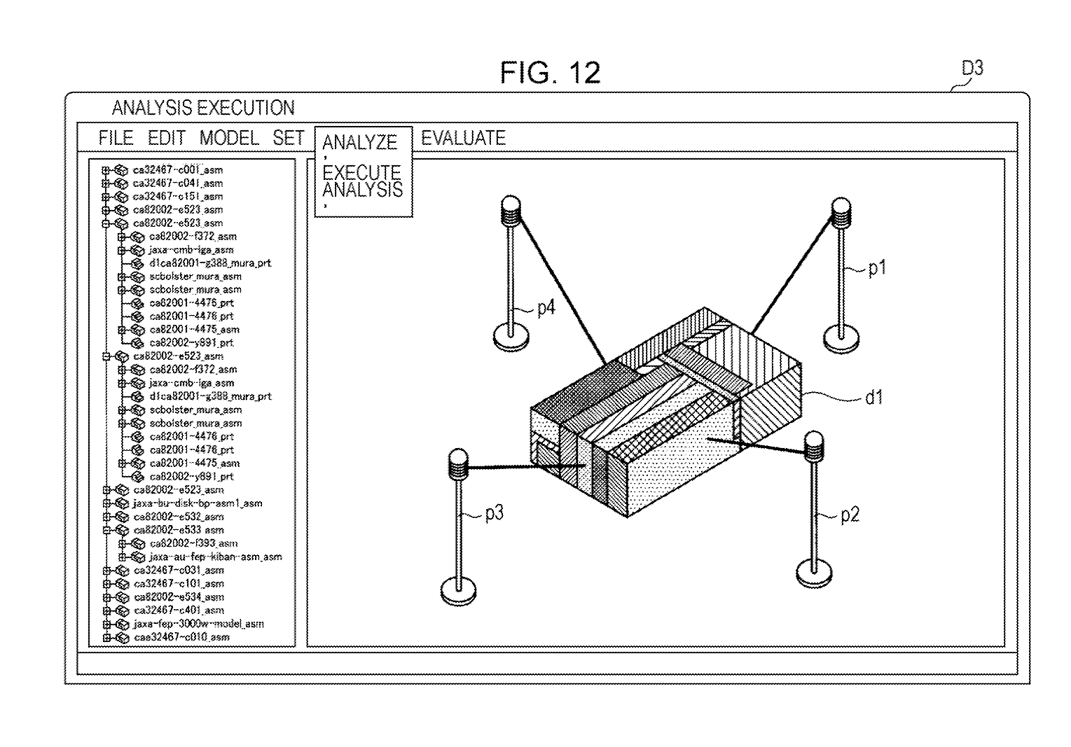

Next, a specific example of an analysis execution screen used in execution of an acoustic analysis process will be described with reference to FIG. 12.

FIG. 12 is a diagram illustrating a specific example of an analysis execution screen. As illustrated in FIG. 12, an analysis object device d1 which is displayed in the form of an analysis model and a plurality of observation points p1 to p4 at which propagation of the sound is observed are displayed on an analysis execution screen D3. For example, the observation point p1 is set on the front side (Front) of the analysis object device d1, the observation point p2 is set on the right side (Right) of the analysis object device d1, the observation point p3 is set on the left side (Left) of the analysis object device d1 and the observation point p4 is set on the rear side (Rear) of the analysis object device d1. The user is allowed to select a command “Analysis Execution” from a toolbar indicated on an upper part on the screen using the mouse or the like with reference to the analysis execution screen D3. Then, the analysis execution screen D3 is allowed to make the device execute the acoustic analysis process by accepting the command “Analysis Execution” from the user.

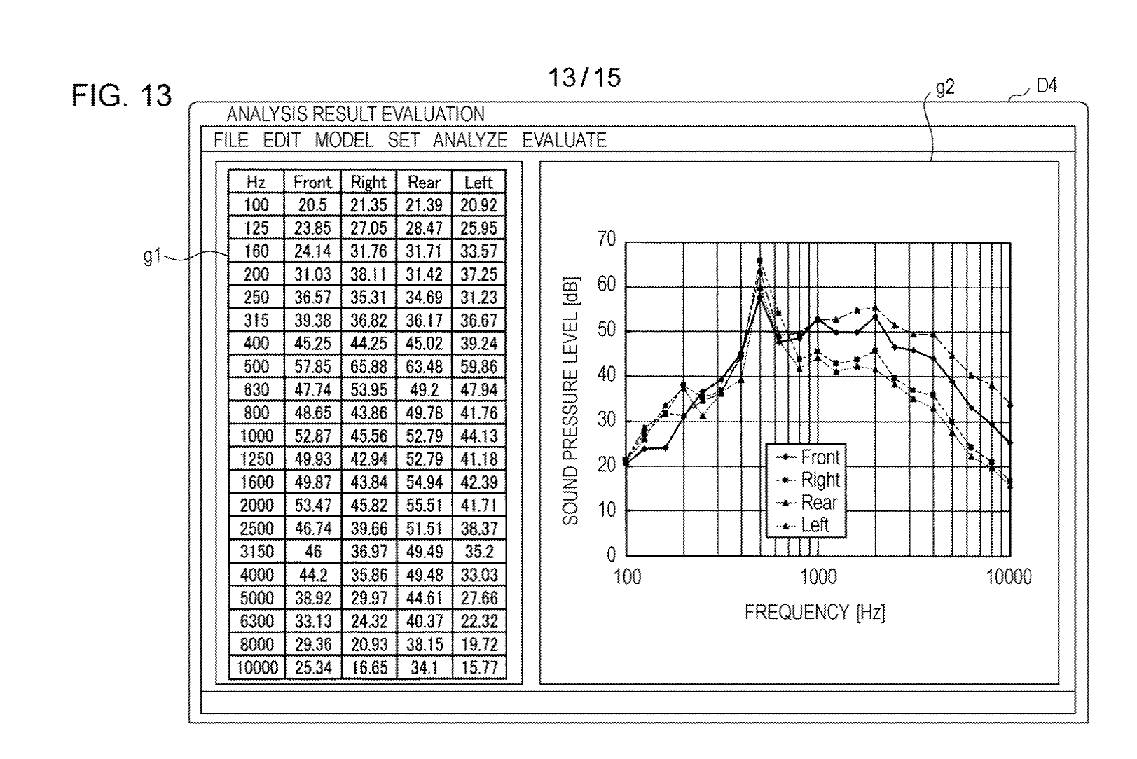

Next, a specific example of an analysis result evaluation screen that the evaluation unit 15 displays as a result of execution of the acoustic analysis process will be described with reference to FIG. 13.

FIG. 13 is a diagram illustrating a specific example of an analysis result evaluation screen. As illustrated in FIG. 13, a table g1 that indicates a relation between each frequency and sound pressure levels measured at a plurality of observation points and a line graph g2 that indicates a relation between each frequency and each sound pressure level are displayed on an analysis result evaluation screen D4. Sound pressure level values observed at the respective observation points on the front side (Front), the right side (Right), the left side (Left) and the rear side (Rear) of the analysis object device are displayed on the table g1 in correspondence with each frequency value. The line graph g2 indicates respective pieces of data which are displayed on the table g1 by plotting the frequency (unit: Hz) on the X-axis and plotting the sound pressure level (unit: dB) on the Y-axis. Incidentally, diagrams to be displayed on the analysis result evaluation screen D4 are not limited to the table g1 and the line graph g2 and a contour map and a color map may be displayed.

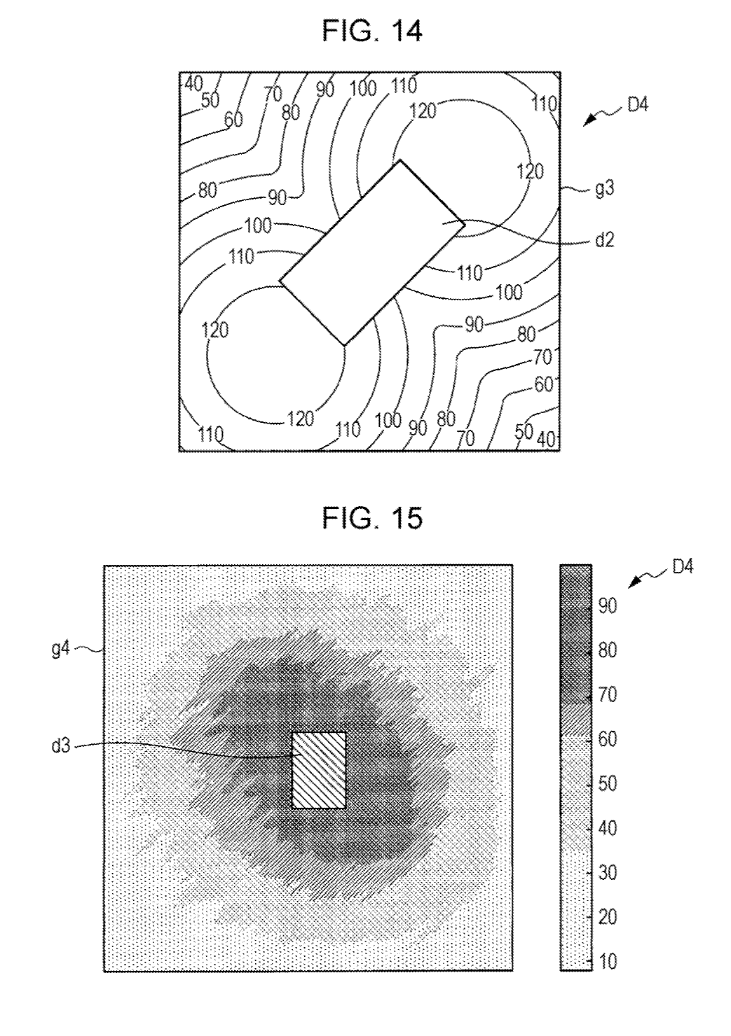

FIG. 14 is a diagram illustrating a specific example in which a contour map is displayed on the analysis result evaluation careen. As illustrated in FIG. 14, a contour map g3 is displayed on the analysis result evaluation screen D4. Areas which are the same as each other in sound pressure level (unit: dB) on the outside of an analysis object device d2 which is displayed in the form of an analysis model are displayed on the contour map g3.

FIG. 15 is a diagram illustrating a specific example in which a two-dimensional color map is displayed on the analysis result evaluation screen. As illustrated in FIG. 15, a two-dimensional color map g4 is displayed on the analysis result evaluation screen D4. Respective sound pressure levels which are obtained on the outside of an analysis object device d3 which is displayed in the form of an analysis model are displayed in different colors on the two-dimensional color map g4. Incidentally, a map to be displayed on the analysis result evaluation screen D4 is not limited to the two-dimensional color map and a three-dimensional color map may be displayed.

[Effects of the Embodiments]

According to the above mentioned embodiments, in the noise analysis device 1, the in-device acoustic analysis unit 12 analyzes propagation of a sound generated within an analysis object device in an internal analysis space of the device by using a first analysis method. Then, the sound power conversion unit 131 converts the unit of a radiated sound which has been analyzed using the in-device acoustic analysis unit 12 and has been radiated from the inside to the outside of the analysis object device to the sound power (the sound energy). Then, the point sound source setting unit 133 sets a plurality of virtual sound sources used as input of a second analysis method which is different from the first analysis method on the basis of the sound power (the sound energy) which has been converted from the unit of the radiated sound using the sound power conversion unit 131. Owing to the above mentioned configuration, in the noise analysis device 1, since the units of radiated sounds which are calculated in units which are different for different first analysis methods adopted are commonly converted to the sound power (the sound energy), it is allowed to commonly use the sound power as the unit of a plurality of virtual sound sources used as input of the second analysis method. Therefore, the noise analysis device 1 is allowed to link a result of analysis executed by the first analysis method to the second analysis method regardless of the type of each of the first and second analysis methods. As a result, it may become possible for the noise analysis device 1 to execute highly accurate acoustic analysis. In addition, it may become possible for the noise analysis device 1 to attain accurate and short-time analysis of a sound such as noise by combing the first analysis method with the second analysis method.

In addition, according to the above mentioned embodiments, in the noise analysis device 1, the point sound source setting unit 133 sets a point sound source commensurate to a sound power (a sound energy) that corresponds to a radiated sound passing through each element of the analysis coupling mesh that covers the analysis object device on each element as a virtual sound source. Owing to the above mentioned configuration, since the point sound source commensurate to the sound power (the sound energy) is set on each meshed point of the analysis coupling mesh, it may become possible for the noise analysis device 1 to correctly transfer the set point sound source from the first analysis method to the second analysis method.

Further, according to the above mentioned embodiments, in the noise analysis device 1, the point sound source setting unit 133 divides each element of the analysis coupling mesh into smaller elements and sets each point sound source corresponding to each divided element on each element so divided as each virtual sound source. Owing to the above mentioned configuration, since the point sound sources used as input of the second analysis method are more finely set on each element of the analysis coupling mesh, it may become possible for the noise analysis device 1 to increase the accuracy of analysis of the sound including noise. In addition, since the point sound sources used as input of the second analysis method are more finely set on each element of the analysis coupling mesh, it may become possible for the noise analysis device 1 to execute flexible acoustic analysis which is based on, for example, the experience of each user.

Still further, according to the above mentioned embodiments, in the noise analysis device 1, the evaluation unit 15 edits a result of acoustic analysis executed using the in-device acoustic analysis unit 12 and a result of acoustic analysis executed using the out-device acoustic analysis unit 14 in the form of a table and a graph and outputs the edited table and graph. Owing to the above mentioned configuration, since the results of acoustic analyses are edited and output in the form of the table and the graph, it may become possible for the noise analysis device 1 to visually indicate the results to the user.

[Others]

Incidentally, in the above mentioned embodiments, the in-device acoustic analysis unit 12 has been described as a unit that analyzes propagation of the sound generated within the analysis object device using, for example, the SEA method. However, the in-device acoustic analysis unit 12 may analyze propagation of the sound within the analysis object device by using a boundary element method (BEM) or a finite element method (FEM) in place of the SEA method. In addition, the in-device acoustic analysis unit 12 analyzes propagation of sounds ranging from a sound having a low frequency of about 20 Hz to a sound having a high frequency of about 10 kHz and analyzes each sound of each frequency each time. Therefore, the in-device acoustic analysis unit 12 may analyze a sound having a frequency value lower than 1 kHz by using the BEM method suited for low-frequency sounds and a sound having a frequency value higher than 1 kHz by using the SEA method suited for high-frequency sounds. Owing to the above mentioned configuration, since an analysis method suited for each frequency may be used for each frequency value, it may become possible for the noise analysis device 1 to execute more accurate acoustic analysis.

The out-device acoustic unit 14 has been described as a unit that analyzes propagation of the sound on the outside of the analysis object device, for example, by a geometrical acoustic method. However, the out-device acoustic analysis unit 14 may analyze propagation of the sound on the outside of the analysis object device by another analysis method in place of the geometrical acoustic method.

In the above mentioned embodiments, description has been made supposing that the internal acoustic analysis mesh which is used as a result of execution of analysis of the sound in the analysis object device is stored in advance in the analysis model database 22 separately from the analysis coupling mesh. However, the invention is not limited to the above and the analysis model preparation unit 11 may prepare the internal acoustic analysis mesh and then store it into the analysis model database 22. In the above mentioned case, the analysis model preparation unit 11 may prepare the internal acoustic analysis mesh on the basis of the data that the input interface unit 30 has input and three-dimensional model data that the design database 21 stores and then may store the prepared internal acoustic analysis mesh into the analysis model database 22.

In addition, the noise analysis device 1 may be implemented by mounting functions of the control unit 10, the storage unit 20, the input interface unit 30 and the output interface unit 40 on an information processing device such as an existing personal computer or work station.

In addition, respective constitutional elements of respective devices illustrated in the drawings need not necessarily be physically configured as illustrated in the drawings. That is, specific manners of distributing and/or integrating respective devices and/or respective constitutional elements therein are not limited to those illustrated in the drawings and all or some of them may be configured by functionally or physically distributing and/or integrating them in an arbitrary unit in accordance with various loads thereon and various usages thereof. For example, the sound power conversion unit 131 and the coupling mesh sound power calculation unit 132 may be integrated together as one unit. On the other hand, the point sound source setting unit 133 may be distributed to a first point sound source setting unit that sets a point sound source on each element of the analysis coupling mesh and a second point sound source setting unit that sets a point sound source on each divided element obtained by dividing each element into several parts. In addition, the storage unit 20 may be connected with the noise analysis device 1 over a network as its external unit. Further, the input interface unit 30 and the output interface unit 40 may be included in separate devices and may be connected into cooperation with each other over a network to implement the above mentioned functions of the noise analysis device 1.

[Program]

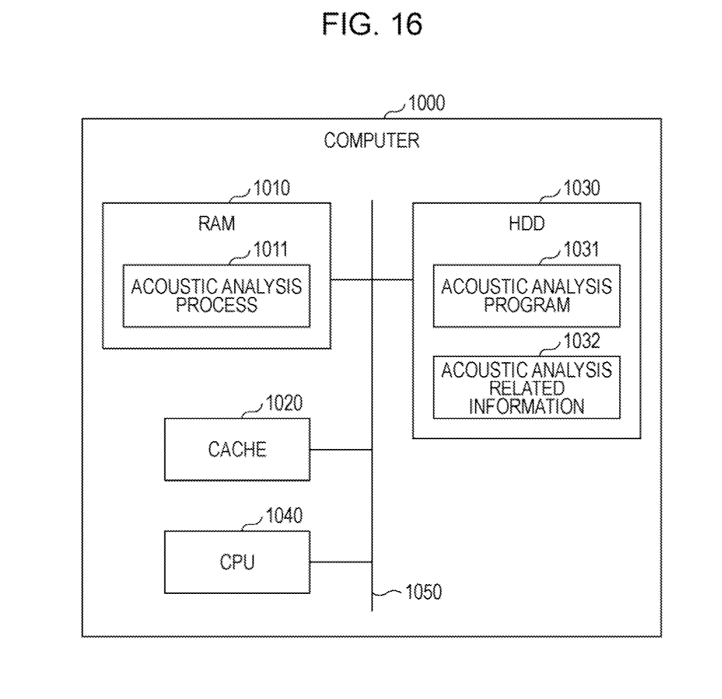

Various processes described in the above embodiments may be implemented by making a computer such as a personal computer, a work station or the like execute a previously prepared program. Thus, in the following, an example of a computer that executes an acoustic analysis program having the same function as the control unit 10 of the noise analysis device 1 illustrated in FIG. 1 will be described with reference to FIG. 16.

FIG. 16 is a diagram illustrating an example of a computer that executes the acoustic analysis program. As illustrated in the example in FIG. 16, a computer 1000 includes a RAM (Random Access Memory) 1010, a cache 1020, an HDD (Hard Disk Drive) 1030, a CPU (Central Processing Unit) 1040 and a bus 1050. The RAM 1010, the cache 1020, the HDD 1030 and the CPU 1040 are connected with one another via the bus 1050.

Then, an acoustic analysis program 1031 having the same function as the control unit 10 illustrated in FIG. 1 is stored in the HDD 1030. In addition, acoustic analysis related information 1032 corresponding to the design database 21, the analysis mode database 22 and the analysis condition database 23 illustrated in FIG. 1 is stored in the HDD 1030.

Then, the CPU 1040 reads the acoustic analysis program 1031 out of the HDD 1030 and expands it in the RAM 1010 to make the acoustic analysis program 1031 function as an acoustic analysis process 1011.

Then, the acoustic analysis process 1011 appropriately expands the information and the like that it has read out of the acoustic analysis related information 1032 in an area which is allocated thereto in the RAM 1010 and executes various data processing on the basis of the data so expanded.

Incidentally, the acoustic analysis program 1031 need not necessarily be stored in a ROM or the HDD 1030. The acoustic analysis program 1031 may be stored in a “portable physical medium” such as, for example, a flexible disk (FD), a CD-ROM, an MO disk, a DVD disk, a magnet-optical disk, an IC card or the like which is inserted into the computer 1000. As an alternative, the acoustic analysis program 1031 may be stored in a “fixed physical medium” such as a hard disk drive (HDD) or the like which is installed on the inside or the outside of the computer 1000 or may be stored in “another computer (or a server)” which is connected with the computer 1000 via a public line, Internet, a LAN, a WAN or the like. Then, the computer 1000 may read the program out of a flexible disk as mentioned above to execute it.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing an acoustic analysis program causing a computer to execute a process, the process comprising:
analyzing propagation of a sound generated within a device in an internal analysis space of the device as a first analysis;
converting a radiated sound that indicates a result of analysis executed and has been radiated from the inside to the outside of the device to sound energy; and
setting a plurality of virtual sound sources to be used as input of a second analysis which is different from the first analysis on the basis of the sound energy which has been converted from the radiated sound by executing the converting process.

2. The computer-readable, non-transitory medium according to claim 1, the process further comprising:
setting a point sound source representing a sound energy which has been converted from the radiated sound passing through each element of meshes that cover the device by executing the converting process on the each element of meshes as a virtual sound source.

3. The computer-readable, non-transitory medium according to claim 2, the process further comprising:
dividing the element of meshes into smaller elements and setting the point sound source corresponding to the smaller elements obtained after the division.

4. The computer-readable, non-transitory medium according to claim 1, the process further comprising:
editing a result of analysis executed by the first analysis and a result of analysis executed by the second analysis in the form of a table or a graph and outputting the table or the graph so edited.

5. An acoustic analysis method executed by a computer, the method comprising:
analyzing propagation of a sound generated within a device in an internal analysis space of the device as a first analysis;
converting a radiated sound that indicates a result of analysis executed and has been radiated from the inside to the outside of the device to sound energy; and
setting a plurality of virtual sound sources used as input of a second analysis which is different from the first analysis on the basis of the sound energy which has been converted from the radiated sound by executing the converting process.

6. An acoustic analysis device comprising:
an analysis unit configured to analyze propagation of a sound generated within a device in an internal analysis space of the device as a first analysis;
a sound energy conversion unit configured to convert a radiated sound that indicates a result of analysis executed using the analysis unit and has been radiated from the inside to the outside of the device to sound energy; and
a virtual sound source setting unit configured to set a plurality of virtual sound sources used as input of a second analysis which is different from the first analysis on the basis of the sound energy which has been converted from the radiated sound by using the sound energy conversion unit.

7. An acoustic analysis device comprising:
a processor configured to execute an acoustic analysis program stored in a recording medium,
wherein an analysis unit analyzes propagation of a sound generated within a device in an internal analysis space of the device as a first analysis,
a sound energy conversion unit converts a radiated sound that indicates a result of analysis executed using the analysis unit and has been radiated from the inside to the outside of the device to sound energy, and
a virtual sound source setting unit sets a plurality of virtual sound sources used as input of a second analysis which is different from the first analysis on the basis of the sound energy which has been converted from the radiated sound by using the sound energy conversion unit; and
a recording medium configured to store the acoustic analysis program.
